(19) United States
(12) Patent Application Publication
(10) Pub. No.: US 2024/0175723 A1
(43) Pub. Date: May 30, 2024

(54) Inductive Sensor Arrangement

(71) Applicant: Robert Bosch GmbH, Stuttgart (DE)

(72) Inventors: Robert Alexander Dauth, Heilbronn (DE); Stefan Kuntz, Flein (DE)

(21) Appl. No.: 18/457,937

(22) Filed: Aug. 29, 2023

(30) Foreign Application Priority Data
Nov. 30, 2022 (DE) 10 2022 212 914.8

(51) Int. Cl. G01D 5/20

(52) U.S. Cl. CPC G01D 5/2073

(57) ABSTRACT

An inductive sensor arrangement for detecting a movement of a movable body includes a movable coupling device coupled to the movable body and a measured-value detection device comprising a circuit carrier with an exciter structure and a receiving structure. The exciter structure is coupled to an oscillator circuit which, during operation, couples a periodic alternating signal into the exciter structure. The movable coupling device is designed to influence an inductive coupling between the exciter structure and the receiving structure. An evaluation and control unit is designed to evaluate signals induced in the receiving structure and to determine a measurement signal for a current position of the movable body. The receiving structure comprises a receiving coil having at least one periodically repeating loop structure, each structure designed as a superposition in the angular direction of a sinusoidal fundamental wave and of at least one harmonic wave of the sinusoidal fundamental wave.

This application claims priority under 35 U.S.C. § 119 to application no. DE 10 2022 212 914.8, filed on Nov. 2, 2022 in Germany, the disclosure of which is incorporated herein by reference in its entirety.

The disclosure relates to an inductive sensor arrangement for determining an angle of rotation of a body which can rotate about a rotation axis.

### BACKGROUND

There are inductive sensor arrangements known from the prior art which can be used to determine an angle of rotation or an angular position or an angular setting of a rotatable body. Such an inductive sensor arrangement typically comprises at least one exciter structure having at least one exciter coil, a rotatable coupling device coupled to the rotatable body, the device also being referred to as a target, and at least one receiving structure having at least one, but usually two, receiving coils. A high-frequency current passes through the exciter coil, generating an alternating magnetic field. The generated alternating magnetic field induces eddy currents in the coupling device, i.e., in the target. Therefore, an inductive coupling between the at least one exciter structure and the at least one receiving structure depends on the angular position of the coupling device, i.e., the target. The voltage signal induced in the at least one receiving structure can provide information on the electrical angle, from which the current angle of rotation or an angular position or an angular setting of the rotatable body can be determined.

Known from DE 197 38 836 A1 is an inductive angle sensor comprising a stator element which has an exciter coil, the coil subjected to a periodic alternating voltage, as well as a plurality of receiving coils, and comprising a rotor element which specifies the strength of the inductive coupling between the exciter coil and the receiving coils as a function of the angular position of the rotor element relative to the stator element, and comprising an evaluation circuit for determining the angular position of the rotor element relative to the stator element from the voltage signals induced in the receiving coils. The rotor element forms at least one short-circuit line which forms a periodically repeating loop structure, at least along sections, in the circumferential direction of the rotor element.

### SUMMARY

The inductive sensor arrangement with the features of the disclosure has the advantage that it is possible to minimize measurement error by introducing harmonic waves, in a targeted way, into a conductor path geometry or a loop structure of at least one receiving structure. In this case, adjusted loop structures of at least one receiving coil of the at least one receiving structure cause a suppression of harmonic measurement errors in the output signal since the harmonic waves introduced into the conductor path geometry, i.e., the loop structure, counteract, in an alternating magnetic field generated by the coupling device, the interfering harmonic waves. For example, this can provide compensation for angle errors when detecting a rotational movement, and for position errors when sensing linear movements.

In contrast to other compensation methods, no computationally complex harmonic compensation is required, for example in a controller of a motor control system, the controller reading in the sensor signals. Likewise, digital linearization in an evaluation and control unit of the inductive sensor arrangement can be omitted, thereby saving costs. Thus, even in applications with high demands on measurement errors, cost-effective analog evaluation- and control units can be used and combined with a cost-effective motor control unit which does not provide any harmonic compensation means. Furthermore, embodiments of the disclosure provide more latitude for minimizing the design space of the inductive sensor arrangement. Until now, the dimensions of the coil geometry, which is determined by the loop structures, were greatly limited by the measurement error requirement. Using embodiments of the disclosure, in a first step the design space and an amplitude of the induced voltage cables can be optimized, and in a second step measurement errors can be reduced.

Embodiments of the present disclosure provide an inductive sensor arrangement for detecting a movement of a movable body, the sensor arrangement having at least one movable coupling device coupled to the movable body and at least one measured-value detection device comprising at least one circuit carrier having at least one exciter structure and at least one receiving structure. The at least one exciter structure is coupled to at least one oscillator circuit which, during operation, couples a periodic alternating signal into the at least one exciter structure. Here, the at least one movable coupling device is designed to influence an inductive coupling between the at least one exciter structure and the at least one receiving structure. At least one evaluation and control unit is designed to evaluate signals induced in the at least one receiving structure and to determine a measurement signal for a current position of the rotatable body. In this case, the at least one receiving structure comprises at least one receiving coil having at least one periodically repeating loop structure, each of which is designed as a superpositioning in the angular direction of a sinusoidal fundamental wave and at least one harmonic wave of the sinusoidal fundamental wave.

In the present case, the evaluation and control unit can be understood as an electrical assembly or electric circuit which processes or evaluates detected sensor signals. The evaluation and control unit can comprise at least one interface, which can be implemented as hardware and/or software. When implemented as hardware, the interfaces can be part of a so-called system ASIC, for example, which contains various functions of the evaluation and control unit. However, it is also possible for the interfaces to be separate, integrated circuits, or to at least partially consist of discrete structural elements. Given a software design, the interfaces can be software modules provided, e.g., on a microcontroller in addition to other software modules. Also advantageous is a computer program product comprising a program code stored on a machine-readable medium, e.g., a semiconductor memory, a hard disk memory, or an optical memory, and used to perform the evaluation when the program is executed by the evaluation and control unit.

The exciter structure is hereinafter understood to mean a transmitter coil having a predetermined number of windings, the coil transmitting the alternating signal which is coupled in by the at least one oscillator circuit. The layout of the at least one receiving coil of the at least one receiving structure is preferably designed differentially, i.e., external homogeneous fields and also the exciting transmission coil field are not the sole contributors to the output signal. A spatially non-homogeneous alternating magnetic field is only generated by the at least one coupling device, which can also be referred to as a target, the magnetic field being demodulated and aiding in the calculation of position. For purposes of the differential configuration, the at least one periodically repeating loop structure of the at least one receiving coil comprises two waves extending between two reversal points which are shifted 180° relative to each other and are each based on the superposition of the sinusoidal fundamental wave and the at least one harmonic wave. In this case, the two waves cover area sections through which the alternating magnetic field to be measured passes in the angular direction in a fashion alternating between positive and negative. This results in opposing directions of passage in the two waves. For example, the flow through a first wave is in the counter-clockwise direction and clockwise in a second wave. This facilitates a simple and inexpensive implementation of the at least one receiving structure on the circuit carrier. Preferably, the circuit carrier is arranged in multiple layers so that portions of the periodically repeating loop structure can be arranged in different layers.

Embodiments of the inductive sensor arrangement can be used for almost all types of inductive angle sensors, for example as a rotary angle sensor or a rotor position sensor, in which the movable body performs a rotational movement about a rotational axis, the movement then being detected. In addition, the measurement principle may also be transferred to torque sensors. For this purpose, two coupling devices and two receiving structures can be used, each of which is associated with and facing one of the coupling devices. Alternatively, embodiments of the inductive sensor arrangement may be embodied as a linear path sensor in which the movable body performs linear movement to be detected.

With the measures and further developments described in the disclosure, advantageous improvements of the sensor assembly for a vehicle specified in the disclosure are possible.

It is particularly advantageous that the periodicity of the periodically repeating loop structure and the sinusoidal fundamental wave may correspond to a periodicity of the coupling device. Here, the periodicity of the coupling device may be determined by a number of electrically-conducting coupling segments. When designing the inductive sensor arrangement as a rotational angle sensor, the coupling device can preferably be designed as a rotor with a base body and a plurality of vanes which form the electrically-conducting coupling segments. Thus, the number of vanes of the coupling device embodied as a rotor determines their periodicity. When designing the inductive sensor arrangement as a linear path sensor, the coupling device may be embodied as a cuboid with a plurality of electrically-conducting coupling segments.

In an advantageous embodiment of the inductive sensor arrangement, the superposition of the at least one harmonic wave and the sinusoidal fundamental wave as a Fourier series can be calculated using at least two summands. This allows a particularly simple calculation of the layout of the at least one periodically repeating loop structure for the at least one receiving coil.

In a preferred embodiment of the inductive sensor arrangement, a harmonic order of the at least one harmonic wave may be three times or five times that of a harmonic order of the sinusoidal fundamental wave. As already stated above, the harmonic order, i.e., the periodicity of the sinusoidal fundamental wave corresponds to the periodicity of the coupling device, so that the harmonic order of the at least one harmonic wave can preferably correspond to three times or five times the value of the periodicity of the sinusoidal fundamental wave.

In a further advantageous embodiment of the inductive sensor arrangement, the at least one harmonic wave can have a phase offset of 0° or 180° relative to the sinusoidal fundamental wave. Of course, however, the harmonic waves may be implemented with any phase offset. Moreover, an amplitude of the at least one harmonic wave for superposition with the sinusoidal fundamental wave can be pre-determined to be in the range of between −20% and +20% of an amplitude of the sinusoidal fundamental wave. The negative amplitudes may preferably be reversed by the phase offset of 180°. In this way, the amplitude of the at least one harmonic wave can be optimized for sensor design purposes such that minimum angular error is achieved, taking all tolerances into account. Common optimization methods can be used for this purpose.

In another advantageous embodiment of the inductive sensor arrangement, the receiving structure can comprise two receiving coils, each having a periodically repeating loop structure. In this case, the periodically repeating loop structures of the two receiving coils may be offset by 90° with respect to each other so that a first receiving coil can form a sine channel and a second receiving coil can form a cosine channel. Also, the at least one evaluation and control unit can be designed to determine the measurement signal from a sine channel signal and from a cosine channel signal using an arctangent function.

Alternatively, the receiving structure may comprise three receiving coils having a periodically repeating loop structure forming a multi-phase system. The at least one evaluation and control unit may be designed to carry out a suitable phase transformation of signals of the multi-phase system, and to determine the measurement signal using an arctangent function. For example, signals of a three-phase system may be transformed into two signals by means of a Clarke transformation, from which the measurement signal may then be determined by means of the arctangent function.

An exemplary embodiment of the disclosure is shown in the drawings and is explained in more detail in the following description. In the drawings, identical reference signs indicate components or elements that perform identical or analogous functions.

### BRIEF DESCRIPTION OF THE DRAWINGS

FIG. 1 shows a schematic illustration of an exemplary embodiment of an inductive sensor arrangement according to the disclosure.

FIG. 2 shows a schematic illustration of the inductive sensor arrangement according to the disclosure from FIG. 1 from below with a transparent circuit carrier shown.

FIG. 3 is a schematic illustration of a detail D of FIG. 2.

### DETAILED DESCRIPTION

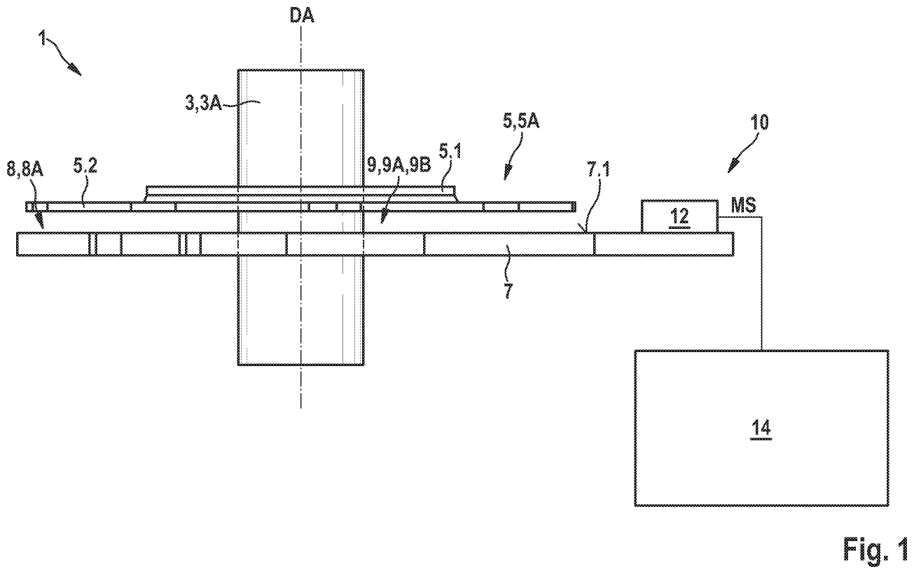

As can be seen in FIGS. 1 to 3, the illustrated exemplary embodiment of an inductive sensor arrangement 1 according to the disclosure for detecting a movement of a movable body 3 comprises at least one movable coupling device 5 coupled to the movable body 3 and at least one measured-value detection device 10 having at least one circuit carrier 7 with at least one exciter structure 8 and at least one receiving structure 9. The at least one exciter structure 8 is coupled to at least one oscillator circuit which, during operation, couples a periodic alternating signal into the at least one exciter structure 8. The at least one movable coupling device 5 influences an inductive coupling between the at least one exciter structure 8 and the at least one receiving structure 9. At least one evaluation and control unit 12 evaluates signals induced in the at least one receiving structure 9 and determines a measurement signal MS for a current position of the movable body 3. In this case, the at least one receiving structure 9 comprises at least one receiving coil 9A, 9B that has at least one periodically repeating loop structure 9.1, 9.2, each of which is designed as a superpositioning, in the angular direction, of a sinusoidal fundamental wave and of at least one harmonic wave of the sinusoidal fundamental wave.

In the illustrated exemplary embodiment, the movable body 3 is a shaft 3A that carries out a rotational movement about a rotational axis DA. The inductive sensor arrangement 1 is used to determine a current angle of rotation of the movable body 3. When the inductive sensor arrangement 1 is designed as a rotational angle sensor, the at least one receiving structure 9 extends along the circular motion path of the coupling device 5. In an alternative exemplary embodiment of the inductive sensor arrangement 1, the movable body 3 carries out a linear movement which is to be detected and evaluated by the inductive sensor arrangement 1. In the process, the inductive sensor arrangement 1 is used to determine a current position of the movable body 3. When the inductive sensor arrangement 1 is designed as a linear path sensor, the at least one receiving structure 9 extends along the linear motion path of the coupling device 5.

As can be further seen from FIGS. 1 to 3, the inductive sensor arrangement 1 in the illustrated exemplary embodiment comprises a coupling device 5, designed as rotor 5A, which is coupled to the rotatable body 3, which is designed as shaft 3A. The rotor 5A is rotatable relative to the circuit carrier 7 and comprises a cylindrical base body 5.1, on which radially projecting electrically-conductive coupling segments 5.2 are arranged as vanes. In the illustrated exemplary embodiment, the rotor 5A comprises nine vanes, i.e., electrically-conducting coupling segments 5.2, the number of which specifies a periodicity of nine for the coupling device 5 and the inductive sensor arrangement 1. The evaluation and control unit 12 determines the measurement signal MS from a sine channel signal and from a cosine channel signal using an arctangent function.

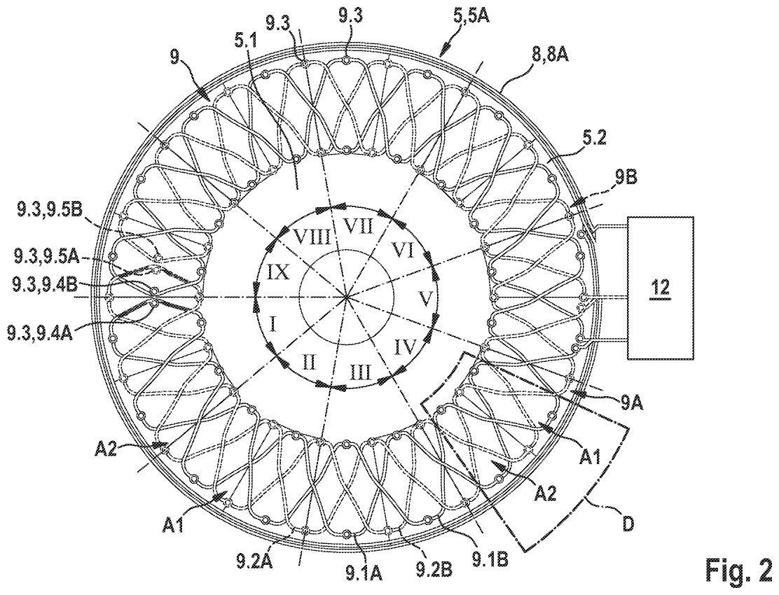

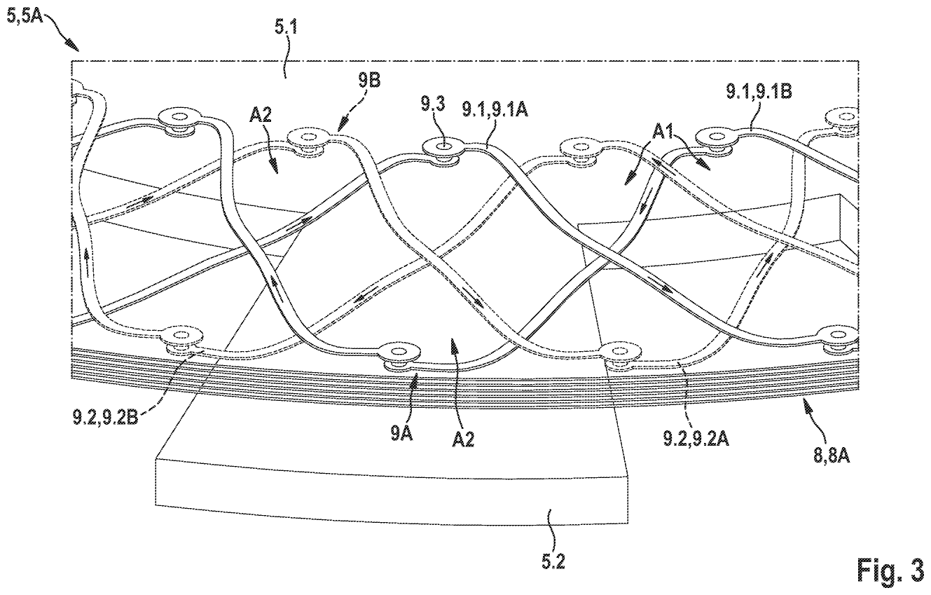

Referring now to FIGS. 2 and 3, the principle design of the receiving structure 9 is described, the circuit carrier 7 being shown transparently. As can be further seen from FIGS. 2 and 3, a periodically repeating first loop structure 9.1 of the first receiving coil 9A and a periodically repeating second loop structure 9.2 of the second receiving coil 9B, shown in dashed lines, each comprise two waves 9.1A, 9.1B, 9.2A, 9.2B, respectively, which run between two reversing points 9.4A, 9.4B, 9.5A, 9.5B, respectively, the waves being shifted by 180° relative to each other and being each based on the superposition of the sine fundamental wave and of the at least one harmonic wave, respectively. As can be further seen, in particular in FIG. 2, a first wave 9.1A and a second wave 9.1B of the periodically repeating first loop structure 9.1, the second wave being displaced by 180° relative to the first wave 9.1A, extend between a first reversing point 9.4A and a second reversing point 9.4B. A first wave 9.2A and a second wave 9.2B, which is shifted by 180° relative to the first wave 9.2A, of the periodically repeating second loop structure 9.2 extend between a first reversing point 9.5A and a second reversing point 9.5B. The periodically repeating second loop structure 9.2 of the second receiving coil 9B is shifted by 90° relative to the periodically repeating first loop structure 9.1 of the first receiving coil 9A. Between the waves 9.1A, 9.1B, 9.2A, 9.2B, which are shifted by 180 relative to each other, of the periodically repeating loop structures 9.1, 9.2 of the two receiving coils 9A, 9B, respectively, there are respective spanned, i.e., enclosed areas A1, A2 in which magnetic fields having different orientations are induced, resulting in opposite directions of passage in the waves 9.1A, 9.1B, 9.2A, 9.2B of the two periodically repeating loop structures 9.1, 9.2 of the two receiving coils 9A, 9B. In the process, the number of such pairs of areas A1, A2 determines the periodicity of the first receiving coil 9A and the second receiving coil 9B, the periodicity corresponding to the number of electrically-conducting coupling segments 5.2, and thus to the periodicity of the coupling device 5. In the process, the number of these pairs of areas determines the periodicity of the second receiving coil 9B of the second receiving structure 9 and corresponds to the second number of electrically-conducting second coupling segments 3.2B of the second coupling element 3B. The Roman numerals I to IX denote the pairs of areas A1, A2 formed by waves 9.1A, 9.1B of the periodically repeating first loop structure 9.1 of the first receiving coil 9A, respectively. The corresponding pairs of areas A1, A2 of the waves 9.2A, 9.2B of the periodically-repeating second loop structure 9.2 of the second receiving coil 9B are shifted by 90° clockwise relative thereto. In the illustrated exemplary embodiment, the first waves 9.1A, 9.2A of the two loop structures 9.1, 9.2 of the two receiving coils 9A, 9B are each passed through in a counter-clockwise direction and the second waves 9.1B, 9.2B of the two loop structures 9.1, 9.2 of the two receiving coils 9A, 9B are each passed through in a clockwise direction. For the purposes of electrical connection to the evaluation and control unit, the first waves 9.1A, 9.2A, respectively, of the two loop structures 9.1, 9.2 of the two receiving coils 9A, 9B are separated and connected to the evaluation and control unit 12.

As can be seen further from FIGS. 2 and 3, portions of the periodically repeating loop structures 9.1, 9.2 of the two receiving coils 9A, 9B are arranged in different layers of the circuit carrier 7 so that intersections can be easily avoided. The sections of the repeating loop structures 9.1, 9.2 which are arranged in different layers are electrically connected to each other using through-contacts 9.3. In addition, the reversing points 9.4A, 9.4B, 9.5A, 9.5B of the two periodically repeating loop structures 9.1, 9.2 of the two receiving coils 9A, 9B are also realized as through-contacts 9.3.

In an alternative embodiment of the inductive sensor arrangement 1, which is not shown, the receiving structures 9 comprise at least three receiving coils having a periodically repeating loop structure. The at least three receiving coils form a multi-phase system. The at least one evaluation and control unit 12 carries out, preferably using a Clarke transformation, a suitable phase transformation of signals of the multi-phase system and determines the measurement signal MS using an arctangent function.

In the illustrated exemplary embodiment of the inductive sensor arrangement 1, the superposition of the at least one harmonic wave and of the sinusoidal fundamental wave for the waves 9.1A, 9.1B, 9.2A, 9.2B of the repeating loop structures 9.1, 9.2 of the two receiving coils 9A, 9B were each calculated as a Fourier series with at least two summands. In the illustrated exemplary embodiment, the at least one harmonic wave has a harmonic order which is five times that of a harmonic order of the sinusoidal fundamental wave of the individual waves 9.1A, 9.1B, 9.2A, 9.2B.

In an alternative embodiment of the repeating loop structures 9.1, 9.2, which is not shown, a harmonic order of the at least one harmonic wave is three times that of a harmonic order of the sine fundamental wave of the individual waves 9.1A, 9.1B, 9.2A, 9.2B. Of course, even-numbered harmonic orders or higher harmonic orders may be used as at least one harmonic wave or a combination of multiple harmonic waves so as to specify the geometry of the individual waves 9.1A, 9.1B, 9.2A, 9.2B, with individual waves 9.1A, 9.1B, 9.2A, 9.2B each having the same fundamental waves and harmonic waves.

In the illustrated exemplary embodiment, the at least one harmonic wave does not have a phase offset relative to the sinusoidal fundamental wave of the corresponding waves 9.1A, 9.1B, 9.2A, 9.2B. Depending on an angular error to be compensated, an amplitude of the at least one harmonic wave for superposition with the sinusoidal fundamental wave can be pre-determined within the range of between −20% and +20% of an amplitude of the sinusoidal fundamental wave.

What is claimed is:

1. An inductive sensor arrangement for detecting a movement of a movable body, comprising:
at least one movable coupling device coupled to the movable body; and
at least one measured-value detection device comprising at least one circuit carrier having at least one exciter structure and at least one receiving structure,
wherein
the at least one exciter structure is coupled to at least one oscillator circuit which, during operation, couples a periodic alternating signal into the at least one exciter structure,
the at least one movable coupling device is designed to influence an inductive coupling between the at least one exciter structure and the at least one receiving structure,
at least one evaluation and control unit is designed to evaluate signals induced in the at least one receiving structure and to determine a measurement signal for a current position of the movable body,
the at least one receiving structure comprises at least one receiving coil having at least one periodically repeating loop structure, each of the at least one periodically repeating loop structure designed as a superposition in an angular direction of a sinusoidal fundamental wave and of at least one harmonic wave of the sinusoidal fundamental wave.

2. The inductive sensor arrangement according to claim 1, wherein the periodicity of the at least one periodically repeating loop structure and the sinusoidal fundamental wave corresponds to a periodicity of the at least one movable coupling device.

3. The inductive sensor arrangement according to claim 1, wherein the superposition of the at least one harmonic wave and of the sinusoidal fundamental wave are calculated as a Fourier series using at least two summands.

4. The inductive sensor arrangement according to claim 1, wherein a harmonic order of the at least one harmonic wave is three or five times that of a harmonic order of the sinusoidal fundamental wave.

5. The inductive sensor arrangement according to claim 1, wherein the at least one harmonic wave has a phase offset of 0° or of 180° relative to the sinusoidal fundamental wave.

6. The inductive sensor arrangement according to claim 1, wherein an amplitude of the at least one harmonic wave for the superposition with the sinusoidal fundamental wave is predetermined in a range between −20% and +20% of an amplitude of the sinusoidal fundamental wave.

7. The inductive sensor arrangement according to claim 1, wherein:
the at least one receiving structure comprises two receiving coils each having a periodically repeating loop structure; and
the periodically repeating loop structures of the two receiving coils are offset 90° relative to each other such that a first of the two receiving coils forms a sine channel and a second of the two receiving coils forms a cosine channel.

8. The inductive sensor arrangement according to claim 7, wherein the at least one evaluation and control unit is designed to determine the measurement signal from a signal of the sine channel and from a signal of the cosine channel using an arctangent function.

9. The inductive sensor arrangement according to claim 1, wherein the at least one receiving structure comprises three receiving coils with a periodically repeating loop structure, the three receiving coils forming a multi-phase system.

10. The inductive sensor arrangement according to claim 9, wherein the at least one evaluation and control unit is designed to carry out a suitable phase transformation of signals of the multi-phase system and to determine the measurement signal using an arctangent function.

11. The inductive sensor arrangement according to claim 1, wherein the movable body performs a rotational movement about a rotational axis or performs a linear movement.
